(19) United States
(12) Patent Application Publication
(10) Pub. No.: US 2008/0161438 A1
(43) Pub. Date: Jul. 3, 2008

(54) Composition comprising copolyetherester elastomer

(76) Inventors: Xingwang Wang, Shanghai (CN); Ruo Fei Zhao, Shanghai (CN); Kye Hyun Kim, Ansan-City (KR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/647,069

(22) Filed: Dec. 28, 2006

(51) Int. Cl. C08L 75/04; C08L 53/00; C08L 33/04; C08L 77/00; C08F 8/00

(52) U.S. Cl. 521/137; 525/98; 525/123; 525/190; 525/194; 521/140; 521/134

(57) ABSTRACT

Disclosed is a composition comprising, consisting essentially of, or consisting of an ethylene polymer, a thermoplastic elastomer, a crosslinking agent, and optionally a foaming agent wherein the ethylene polymer includes ethylene vinyl acetate copolymer, polyethylene, ethylene acid copolymer, ionomer of the acid copolymer, ethylene alkyl(meth)acrylate copolymer, or combinations of two or more thereof; the thermoplastic elastomer can include copolyetherester, copolyetheramide, elastomeric polyolefin, styrene diene block copolymers, thermoplastic polyurethane, or combinations of two or more thereof; and the crosslinking agent includes one or more organic peroxides, irradiation, or combinations thereof. Also disclosed is a product made from the composition such as foam for shoe applications.

### FIELD OF THE INVENTION

The invention relates to a composition comprising a copolyetherester elastomer and a product therewith.

### BACKGROUND OF THE INVENTION

An injection-molding foam process (IP) was developed more than a decade ago to overcome the drawbacks of labor-intensive compression molding. This process has not been widely accepted due to the lack of high-quality compounds needed to reproduce exactly the same size from shot to shot over production cycles lasting several days. In such processes, achieving a balance between density and performance properties (e.g., compression set) can be difficult to attain.

For many years, copolymer of ethylene vinyl acetate (EVA) has been the preferred material for footwear foam applications. Crosslinked EVA foams, expanded with chemical blowing agents, provide an attractive balance of resilience, durability and other physical properties that are required for sole applications in footwear. These properties are provided at a low density, which is desirable for a lighter weight, and at an attractive cost. However, EVA has a limitation in attaining softness such as surface softness, a low compression set, and a high resilience. As the foam process moves toward the one-step, injection-molding process, it becomes more difficult to attain EVA foam having balanced properties, i.e., having high resilience, low compression set, and high split tear strength.

Injection-molded EVA foam sacrifices some of the performance of conventional compression-molded (CM) EVA foams. As compared to CM-EVA foam, the IP-EVA foam, in general, is less resilient, its surface tends to be harder, and its compression set is higher. It appears that it is more difficult to obtain EVA foam with balanced properties in the IP process than in the CM process because the foam is produced in one step by IP process, while it is produced by a two-step process.

### SUMMARY OF THE INVENTION

A composition comprising or produced from an ethylene polymer, a thermoplastic elastomer, a crosslinking agent, and optionally a foaming agent wherein

the ethylene polymer includes ethylene vinyl acetate copolymer, polyethylene, ethylene acid copolymer, ionomer of the acid copolymer, ethylene alkyl(meth)acrylate copolymer, or combinations of two or more thereof;

the thermoplastic elastomer can include copolyetherester, copolyetheramide, elastomeric polyolefin, styrene diene block copolymers, thermoplastic polyurethane, or combinations of two or more thereof; and

the crosslinking agent can include one or more organic peroxides, irradiation, or combinations thereof.

### DETAILED DESCRIPTION OF THE INVENTION

Ethylene/vinyl acetate (EVA) copolymer is a polymer well known to one skilled in the art. The relative amount of vinyl acetate comonomer incorporated into EVA can be from 0.1 weight % up to as high as 40 weight percent of the total copolymer or even higher. For example, EVA can have a vinyl acetate content of from 2 to 50% by weight, 10 to 40%, or 6 to 30% by weight. EVA may be modified by methods well known in the art, including modification with an unsaturated carboxylic acid or its derivatives, such as maleic anhydride or maleic acid. EVA may have a melt flow rate (ASTM D-1238) from 0.1 to 60 g/10 minutes, or 0.3 to 30 g/10 minutes.

Polyethylene (PE) can include PE homopolymers and copolymers such as high density polyethylene, low density polyethylene, linear low density polyethylene, very low density polyethylene, ultra-low density polyethylene, metallocene-catalyzed polyethylene, ethylene propylene copolymer, ethylene/propylene/diene monomer (EPDM) terpolymer, ethylene copolymer derived from ethylene and CO, grafted compositions of one of these polymers with maleic acid (or maleic anhydride or maleic acid mono-ester), or combinations of two or more thereof. Commercial PE includes a copolymer of ethylene and 1-butene containing 12.6 weight % 1-butene, having a melt index of 3.5 available as Exact® from ExxonMobil and a copolymer of ethylene and 1-octene with 12 weight % octene, having a melt index of 3.5 available as Engage® from DuPont Performance Elastomers.

Ethylene-containing polymers may also include one or more ethylene copolymers obtained from copolymerization of ethylene with at least one polar monomer such as ethylene/vinyl acetate copolymers, ethylene/acrylic ester copolymers, ethylene/methacrylic ester copolymers, ethylene/vinyl acetate/CO copolymers, ethylene/acrylic ester/CO copolymers, and/or mixtures of any of these.

Ethylene acid copolymer can comprise repeat unites derived from ethylene and an unsaturated carboxylic acid or derivative thereof such as (meth)acrylic acid, maleic acid, fumaric acid, itaconic acid, maleic anhydride, fumaric anhydride, maleic acid (maleic half esters) including esters of C₁ to C₄ alcohols (e.g., methyl, ethyl, n-propyl, isopropyl and n-butyl alcohols), or combinations of two or more thereof. An example of acid copolymer can be described as E/X/Y copolymer where E is ethylene, X can be at least one unsaturated carboxylic acid disclosed above, and Y is a softening comonomer such as alkyl acrylate, alkyl methacrylate, or combinations thereof. X can be present from about 3 to about 30, 4 to 25, or 5 to 20, weight % of the E/X/Y copolymer, and Y is from 0 to about 35, 0.1 to 35, or 5 to 30, weight % of the E/X/Y copolymer.

Examples of acid copolymers include ethylene/(meth)acrylic acid copolymers, ethylene/(meth)acrylic acid/n-butyl(meth)acrylate copolymers, ethylene/(meth)acrylic acid/iso-butyl(meth)acrylate copolymers, ethylene/(meth)acrylic acid/tert-butyl(meth)acrylate copolymers, ethylene/(meth)acrylic acid/methyl(meth)acrylate copolymers, ethylene/(meth)acrylic acid/ethyl(meth)acrylate copolymers, ethylene/maleic acid and ethylene/maleic acid monoester copolymers, ethylene/maleic acid monoester/n-butyl(meth)acrylate copolymers, ethylene/maleic acid monoester/methyl(meth)acrylate copolymers, ethylene/maleic acid monoester/ethyl(meth)acrylate copolymers, or combinations of two or more thereof such as Nucrel® commercially available from E. I. du Pont de Nemours and Company, Wilmington, Del. (DuPont).

Ionomers can be prepared from the acid copolymer by treatment with a basic compound capable of neutralizing the acid moieties of the copolymer. The acid groups may be nominally neutralized to any level from about 0.1 to about 90%, about 15 to about 80%, or about 40 to about 75% with an alkaline earth metal ion, an alkali metal ion, or a transition metal ion. lonomers can also be prepared with nominal neutralization levels higher than 70% as disclosed above when blended with the organic acids.

Processes for producing acid copolymer and ionomers are well known to one skilled in the art and, the description of which is omitted herein for the interest of brevity.

Ethylene alkyl(meth)acrylate copolymer comprises repeat units derived from ethylene and alkyl acrylate, alkyl methacrylate, or combinations thereof wherein the alkyl moiety contains from 1 to 8 carbon atoms. Examples of alkyl include methyl, ethyl, propyl, butyl, or combinations of two or more thereof. Alkyl(meth)acrylate comonomer may be incorporated into the ethylene/alkyl(meth)acrylate copolymer from 0.1 weight % up to 45 weight % of the total copolymer or even higher. The alkyl group can contain 1 to about 8 carbons. For example, the alkyl(meth)acrylate comonomer can be present in the copolymer from 5 to 45, 10 to 35, or 10 to 28, weight %. Ethylene alkyl(meth)acrylate copolymers can be produced by processes well known in the art using either autoclave or tubular reactors. See e.g., U.S. Pat. Nos. 5,028,674; 2,897,183; 3,404,134; 5,028,674; 6,500,888 and 6,518,365, the disclosures of which are incorporated herein by reference. Because the processes are well known, the disclosure of which is omitted herein for the interest of brevity. Examples of ethylene alky(meth)acrylate copolymer include ethylene/methyl acrylate, ethylene/ethyl acrylate, ethylene/butyl acrylate, or combinations of two or more thereof such as Elvaloy® commercially available from DuPont. A mixture of two or more different ethylene alkyl(meth)acrylate copolymers can be used.

The thermoplastic elastomer can include copolyetherester, copolyetheramide, elastomeric polyolefin, styrene diene block copolymers, thermoplastic polyurethane, or combinations of two or more thereof which are polymers being well known in the art.

Copolyetherester includes one or more copolymers having a multiplicity of recurring long-chain ester units and short-chain ester units joined head-to-tail through ester linkages. The long-chain ester unit comprises repeat units of —OGO—C(O)RC(O)— and the short chain ester unit comprises repeat units of —OGO—C(O)RC(O)—. G is a divalent radical remaining after the removal of terminal hydroxyl groups from poly(alkylene oxide)glycols having a number average molecular weight of between about 400 and about 6000, or preferably between about 400 and about 3000. R is a divalent radical remaining after removal of carboxyl groups from a dicarboxylic acid having a molecular weight of less than about 300. D is a divalent radical remaining after removal of hydroxyl groups from a diol having a molecular weight less than about 250.

The copolyetherester preferably contains about 15 to about 99 weight % short-chain ester units and about 1 to about 85 weight % long-chain ester units, or from about 25 to about 90 weight % short-chain ester units and about 10 to about 75 weight % long-chain ester units.

The copolyetheresters are disclosed in US patents including U.S. Pat. No. 3,651,014, U.S. Pat. No. 3,766,146, and U.S. Pat. No. 3,763,109, the disclosures if which are incorporated herein by reference. A commercially available copolyetherester is Hytrel® from DuPont. Others include Arnitel® from DSM in the Netherlands and Riteflex® from Ticona, USA.

Copolyetheramide is also well known in the art as disclosed in U.S. Pat. No. 4,331,786, the disclosure of which is incorporated herein by reference. They comprise a linear and regular chain of rigid polyamide segments and flexible polyether segments, as represented by the formula HO—[C(O)PAC(O)OPEO]ₙ—H where PA is a linear saturated aliphatic polyamide sequence formed from a lactam or amino acid having a hydrocarbon chain containing 4 to 14 carbon atoms or from an aliphatic C₆-C₉ diamine, in the presence of a chain-limiting aliphatic carboxylic diacid having 4-20 carbon atoms. The polyamide has an average molecular weight between 300 and 15,000. PE is a polyoxyalkylene sequence formed from one or more linear or branched aliphatic polyoxyalkylene glycols or copolyethers derived therefrom said polyoxyalkylene glycols having a molecular weight of less than or equal to 6000. The subscript n indicates a number of repeat units so that the polyetheramide copolymer has an intrinsic viscosity of from about 0.8 to about 2.05. Because it is well known (see, e.g., U.S. Pat. No. 6,815,480, the disclosure of which is incorporated herein by reference), the process for producing the polyetheramide is omitted herein for the interest of brevity.

Elastomeric polyolefin comprises repeat units of ethylene and higher primary olefins such as propylene, hexene, octene, or combinations of two or more thereof and optionally 1,4-hexadiene, ethylidene norbornene, norbornadiene, or combinations of two or more thereof. The elastomeric polyolefins can be functionalized by grafting with an acid anhydride such as maleic anhydride. Because elastomeric polyolefins are well known, the process therefor is omitted herein for the interest of brevity.

Block styrene diene copolymer comprises repeat units derived from polystyrene units and polydiene units. The polydiene units are derived from polybutadiene, polyisoprene units or copolymers of these two. The copolymer may be hydrogenated to produce a saturated rubbery backbone segments commonly referred to as SBS, SIS, or SEBS thermoplastic elastomers. They also can be functionalized by grafting with an acid anhydride such as maleic anhydride. Because styrene diene copolymers are well known, the process therefor is omitted herein for the interest of brevity.

Thermoplastic polyurethanes are linear or slightly chain branched polymers consisting of hard blocks and soft elastomeric blocks. They can be produced by reacting soft hydroxy terminated elastomeric polyethers or polyesters with diisocynates such as methylene diisocynate or toluene diisocynate. These polymers can be chain extended with glycols, diamines, diacids, or amino alcohols. The reaction products of the isocynates and the alcohols are urethanes and these blocks are relatively hard and high melting. These hard high melting blocks are responsible for the thermoplastic nature of the polyurethanes.

Commonly employed crosslinking agent includes one or more organic peroxides including dialkyl peroxides, peroxy esters, peroxy dicarbonates, peroxy ketals, diacyl peroxides, or combinations of two or more thereof. Examples of peroxides include dicumyl peroxide, di(3,3,5-trimethyl hexanoyl)peroxide, t-butyl peroxypivalate, t-butyl peroxyneodecanoate, di(sec-butyl)peroxydicarbonate, t-amyl peroxyneodecanoate, 1,1-di-t-butyl peroxy-3,3,5-trimethylcyclohexane, t-butyl-cumyl peroxide, 2,5-dimethyl-2,5-di(tertiary-butyl-peroxyl)hexane, 1,3-bis(tertiary-butyl-peroxyl-isopropyl)benzene, or combinations of two or more thereof. These and other peroxides are available under the Luperox® from Arkema or the Trigonox® from Akzo Nobel.

A foaming agent, also referred to as blowing agent, including a chemical blowing agent or a physical blowing agent. Chemical blowing agent includes azodicarbonamide, dinitroso-pentamethylene-tetramine, p-toluene sulfonyl hydrazide, p,p′-oxy-bis(benzenesulfonyl hydrazide), or combinations of two or more thereof, and optionally one or more organic or inorganic blowing agents. Physical blowing agents are halocarbons, volatile organic compounds, or non-flammable inert atmosphere gases, or combinations of two or more thereof. To tailor expansion-decomposition temperature and foaming processes, a blowing agent may also be a mixture of blowing agents or of blowing agents and an activator.

The composition may include about 0.1 to about 10% or about 1 to 5% by weight (of the composition) an activator (for the blowing agent) to lower the decomposition temperature/profile of blowing agents. An activator can be one or more metal oxides, metal salts, or organometallic complexes, or combinations of two or more thereof. Examples include ZnO, Zn stearate, MgO, or combinations of two or more thereof.

Other additives, which can be present in the composition from about 0.1 to about 20 or about 2 to about 12% by weight of the composition, may include, pigment (TiO₂ and other compatible colored pigments), adhesion promoter (to improve adhesion of the expanded foam to other materials), filler (e.g., calcium carbonate, barium sulfate, and/or silicon oxide), nucleating agent (pure form or concentrate form, e.g., CaCO₃, ZnO, SiO₂, or combinations of two or more thereof, rubber (to improve rubber-like elasticity, such as natural rubber, SBR, polybutadiene, and/or ethylene propylene terpolymer), stabilizer (e.g., antioxidants, UV absorbers, and/or flame retardants), and processing aids (e.g., Octene R-130 manufactured by Octene Co., Taiwan). Antioxidant (modifying the organoleptic properties such as reducing odor or taste) can include phenolic antioxidants such as IRGANOX from Ciba Geigy Inc. (Tarrytown, N.Y.).

The composition can comprise about 50 to about 98 wt % or about 70 to about 90 wt % of the ethylene polymer. If EVA and ethylene copolymer are present, EVA can be present in the range of from about 60 to about 90% of the total weight of the ethylene polymer. The thermoplastic elastomer can be present in the composition in the range of from about 0.1 to about 20 or about 1 to about 10 wt % of the composition. Other components include, all by weight of the composition, about 0.01 or 0.1 to about 2% crosslinking agents, about 0.5 to about 10% blowing agent, about 0.1 to 10% activator, and about 0.0001 to about 10% one or more other additives.

The composition may be produced by a number of processes, such as compression molding, injection molding, or hybrids of extrusion and molding. For example, a process can comprise mixing the polymers and crosslinking agents under heat to form a melt, along with blowing agents, and other additives, to achieve a homogeneous compound. The ingredients may be mixed and blended by any means known in the art such as with a Banbury, intensive mixers, two-roll mill, and extruder. Time, temperature, shear rate may be regulated to ensure optimum dispersion without premature crosslinking or foaming. A high temperature of mixing may result in premature crosslinking and foaming by decomposition of peroxides and blowing agents. An adequate temperature may be desired to insure good mixing of polymers and the mixing or dispersion of other ingredients. The polymers can form a uniform blend when blended at temperatures of about 60° C. to about 150° C., or about 80° C. to about 150° C., or about 70° C. to about 120° C. or about 80° C. to about 130° C. The upper temperature limit for safe operation may depend on the onset decomposition temperatures of peroxides and blowing agents employed. The polymers may be melt-blended before compounded with other ingredient(s).

Optionally, polymers can be melt-blended in an extruder at a temperature up to about 250° C. to allow potentially good mixing. The resultant mixture can be then compounded with the ingredients disclosed above.

After mixing, shaping can be carried out. Sheeting rolls or calendar rolls are often used to make appropriately dimensioned sheets for foaming. An extruder may be used to shape the composition into pellets.

Foaming can be carried out in a compression mold at a temperature and time to complete the decomposition of peroxides and blowing agents. Pressures, molding temperature, and heating time may be controlled. Foaming can be carried out in an injection molding equipment by using foam composition in pellet form. The resulting foam can be further shaped to the dimension of finished products by any means known in the art such as by thermoforming and compression molding.

The foam produced from the composition can be substantially closed cell and useful for a variety of articles including footwear application (e.g., midsoles or insoles), automotive seat and interiors, furniture armrest, railway pad, and other industrial foam material applications.

The invention can be illustrated by the following examples, which are not to be construed as to limit the scope of the invention.

### EXAMPLES

### Comparable Example 1

EVA (DuPont Elvax® 2288) 2000 g, DCP (dicumyl peroxide) 20.3 g, blowing agent AZ-H (modified Azodicarbonamide) 74.5 g, TiO2 180 g, and ZnO 80 g.

### Comparable Example 2

EMA (ethylene methyl acrylate copolymer, DuPont Elvaloy® AC 1224) 600 g, EVA (DuPont Elvax® 2288) 1400 g, DCP 20.3 g, blowing agent (AZ-H) 64.4 g, TiO2 180 g, and ZnO 80 g.

### Example 1

EMA (DuPont Elvaloy® AC 1224; 275 g), EVA (DuPont Elvax® 2288; 1600 g), copolyether-ester block copolymer (DuPont Hytrel® 4056; 125 g), TiO₂ (180 g), ZnO (80 g), DCP (20.3 g), and AZ-H (66.67 g).

### Example 2

EMA (DuPont Elvaloy® AC 1224; 300 g), EVA (DuPont Elvax® 2288; 1500 g), copolyether-ester block copolymer (DuPont Hytrel® 4056; 100 g), TiO₂(180 g), ZnO (80 g), DCP (19.4 g), and AZ-H (62.64 g).

The table below shows that the EVA foams modified with copolyether-ester block copolymer had lower compression set. Foaming was done at 165° C. for 10 minutes.

Compression test was carried out as follows. Molded square plaque having about 10 mm thickness was used. Two or three 2.54 cm diameter circles were cut from the plaque. Mark exact location where gauge (for identifying the thickness) was taken.

Load the circles into metal compression plate apparatus and compress the circles to 50% of original thickness. The circles were place in a preheated 50° C. oven for 6 hours with compression plates set on their sides. At the end of the time period, the apparatus was removed from the oven and the samples were taken out immediately. After cooling for 30 minutes at room temperature (22±2° C.), the final sample gauge were marked and compute percent (%) compression set for each sample as follows: % Set=((Original gauge−final gauge)/(Original gauqe−50% Compressed gauge))×100.

Split tear strength test was carried out according to the ASTM D3574.

The Test Results are Shown in the Following Table.

| | | | | Split tear |
|---|---|---|---|---|
| | Foam | | Compression | strength |
| | density (g/cc) | Hardness | set (%) | (N/mm) |
| Comparative 1 | 0.22 | 53.5 | 63 | 1.64 |
| Comparative 1 | 0.22 | 62.3 | 54 | 2.01 |
| Example 1 | 0.21 | 60 | 45 | 2.2 |
| Example 2 | 0.22 | 59 | 42 | 2.52 |

1. A composition comprising or produced from an ethylene polymer, a thermoplastic elastomer, a crosslinking agent, and optionally a foaming agent wherein
the ethylene polymer includes ethylene vinyl acetate copolymer, polyethylene, ethylene acid copolymer, ionomer of the acid copolymer, ethylene alkyl(meth)acrylate copolymer, or combinations of two or more thereof;
the thermoplastic elastomer includes copolyetherester, copolyetheramide, elastomeric polyolefin, styrene diene block copolymers, thermoplastic polyurethane, or combinations of two or more thereof; and
the crosslinking agent includes one or more organic peroxides, irradiation, or combinations thereof.

2. The composition of claim 1 wherein the ethylene copolymer includes the ethylene vinyl acetate copolymer, the ethylene alkyl(meth)acrylate copolymer, or combinations thereof.

3. The composition of claim 2 wherein, the ethylene copolymer includes the ethylene vinyl acetate copolymer and the ethylene methyl acrylate copolymer.

4. The composition of claim 2 wherein the thermoplastic elastomer can include copolyetherester.

5. The composition of claim 3 wherein the thermoplastic elastomer can include copolyetherester.

6. The composition of claim 1 wherein the crosslinking agent includes dicumyl peroxide, di(3,3,5-trimethyl hexanoyl)peroxide, t-butyl peroxypivalate, t-butyl peroxyneodecanoate, di(sec-butyl)peroxydicarbonate, t-amyl peroxyneodecanoate, 1,1-di-t-butyl peroxy-3,3,5-trimethylcyclohexane, t-butyl-cumyl peroxide, 2,5-dimethyl-2,5-di(tertiary-butyl-peroxyl)hexane, 1,3-bis(tertiary-butyl-peroxyl-isopropyl)benzene, or combinations of two or more thereof.

7. The composition of claim 3 wherein the crosslinking agent includes dicumyl peroxide.

8. The composition of claim 5 wherein the crosslinking agent includes dicumyl peroxide.

9. The composition of claim 2 further comprising the foaming agent.

10. The composition of claim 4 further comprising the foaming agent.

11. The composition of claim 6 further comprising the foaming agent including azodicarbonamide, dinitroso-pentamethylene-tetramine, p-toluene sulfonyl hydrazide, p,p′-oxy-bis(benzenesulfohydrazide), or combinations of two or more thereof.

12. The composition of claim 8 further comprising the foaming agent including a blend azodicarbonamide, p-toluene sulfonyl hydrazide, and optionally one or more organic or inorganic blowing agents.

13. The composition of claim 9 further comprising an activator including one or more metal oxides, metal salts, organometallic complexes, or combinations of two or more thereof.

14. The composition of claim 11 further comprising an activator including ZnO, Zn stearate, MgO, or combinations of two or more thereof.

15. The composition of claim 12 further comprising an activator including ZnO.

16. A composition comprising or produced from an ethylene polymer, a thermoplastic elastomer, a crosslinking agent, and a foaming agent wherein the ethylene polymer includes ethylene vinyl acetate copolymer and ethylene methyl acrylate copolymer; the thermoplastic elastomer includes a copolyetherester; the crosslinking agent includes dicumyl peroxide; the foaming agent includes a blend azodicarbonamide, p-toluene sulfonyl hydrazide, and optionally one or more organic or inorganic blowing agents; the foaming agent comprises an activator including ZnO, and the composition optionally comprises an additive including TiO₂.

17. An article comprising or produced from a composition wherein
the article includes midsole or insole of footwear, automotive seat and interior, furniture armrest, railway pad, or combinations of two or more thereof;
the composition comprises or is produced from an ethylene polymer, a thermoplastic elastomer, a crosslinking agent, and a foaming agent;
the ethylene polymer includes ethylene vinyl acetate copolymer, polyethylene, ethylene acid copolymer, ionomer of the acid copolymer, ethylene alkyl(meth)acrylate copolymer, or combinations of two or more thereof;
the thermoplastic elastomer includes copolyetherester, copolyetheramide, elastomeric polyolefin, styrene diene block copolymers, thermoplastic polyurethane, or combinations of two or more thereof; and
the crosslinking agent includes one or more organic peroxides, irradiation, or combinations thereof.

18. The article of claim 17 wherein the article includes midsole or insole of footwear.

19. The article of claim 18 wherein
the ethylene copolymer includes the ethylene vinyl acetate copolymer, the ethylene alkyl(meth)acrylate copolymer, or combinations thereof;
the crosslinking agent includes dicumyl peroxide, di(3,3,5-trimethyl hexanoyl)peroxide, t-butyl peroxypivalate, t-butyl peroxyneodecanoate, di(sec-butyl)peroxydicarbonate, t-amyl peroxyneodecanoate, 1,1-di-t-butyl peroxy-3,3,5-trimethylcyclohexane, t-butyl-cumyl peroxide, 2,5-dimethyl-2,5-di(tertiary-butyl-peroxyl)hexane, 1,3-bis(tertiary-butyl-peroxyl-isopropyl)benzene, or combinations of two or more thereof;
the foaming agent includes azodicarbonamide, dinitroso-pentamethylene-tetramine, p-toluene sulfonyl hydrazide, p,p′-oxy-bis(benzenesulfohydrazide), or combinations of two or more thereof; and the foaming agent optionally comprises an activator including ZnO.

20. The article of claim 18 wherein the ethylene polymer includes ethylene vinyl acetate copolymer and ethylene methyl acrylate copolymer; the thermoplastic elastomer includes a copolyetherester; the crosslinking agent includes dicumyl peroxide; the foaming agent includes a blend azodicarbonamide, p-toluene sulfonyl hydrazide, and optionally one or more organic or inorganic blowing agents; and the foaming agent comprises the activator including ZnO and optionally an additive including TiO₂.
